(19) United States
(12) Patent Application Publication
(10) Pub. No.: US 2012/0134153 A1
(43) Pub. Date: May 31, 2012

(54) LIGHT SOURCE UNIT, LIGHT SOURCE DEVICE, AND ILLUMINATION DEVICE

(75) Inventors: NORIMASA SUZUKI, KANAGAWA-KEN (JP); Keiichi Shimizu, Yokosuka-Shi (JP); Masaru Matsuno, Kanagawa-ken (JP); Yoshiro Oka, Kanagawa-Ken (JP)

(73) Assignees: KABUSHIKI KAISHA TOSHIBA, TOKYO (JP); TOSHIBA LIGHTING & TECHOLOGY CORPORATION, YOKOSUKA-SHI (JP)

(21) Appl. No.: 13/366,996

(22) Filed: Feb. 6, 2012

Related U.S. Application Data
(63) Continuation of application No. PCT/JP2010/004922, filed on Aug. 5, 2010.

(30) Foreign Application Priority Data
Aug. 7, 2009 (JP) P2009-185297
Feb. 2, 2010 (JP) P2010/ 021683

(51) Int. Cl. F21V 7/04; F21V 7/08; F21V 7/06

(52) U.S. Cl. 362/238; 362/296.05; 362/296.06; 362/296.07; 362/296.08

(57) ABSTRACT

A light source unit includes a light-emitting element 52 such as a LED provided on an inner surface of a side wall 4, and a reflecting surface 31 opposed to the light-emitting element 52 with the side wall 4 made parallel to a direction of radiation of the reflecting surface 31, the reflecting surface 31 formed of a part of a curved surface formed by a paraboloid of revolution or the like that is obtained by revolving a parabola and is spread and opened in the direction of radiation.

### TECHNICAL FIELD

Embodiments of the present invention relate to a light source unit, a light source device, and an illumination device, which are suitable for performing lighting-up or the like to produce beautiful effects on night scenery.

### BACKGROUND ART

In an illumination device known heretofore, a reflecting surface for reflecting light emitted from a lamp is shaped in a paraboloid of revolution obtained by revolving a parabola, and a light center of the lamp is located at a focal point of this paraboloid of revolution (see Patent Document 1, for example). With this configuration, the light reflected by the reflecting surface is radiated as substantially parallel light. Therefore, in order to produce effective illumination by irradiating an object with a spotlight, for example, it is preferable to locate the light center of the lamp at the focal point of the reflecting surface by use of the configuration as shown in Patent Document 1.

However, when light-emitting elements such as LEDs are used as a light source, the LEDs or the like are usually installed on a base plate by surface mounting or the like, and form a fiat plate shape. For this reason, by adjusting the levels of the LEDs or the like, for example, it is difficult to locate the light center of the LEDs or the like at the focal point of the reflecting surface formed of the paraboloid of revolution. This causes a problem that an object cannot be effectively irradiated with light due to an increase in beam divergence or diffusion of the reflected light.

### PRIOR ART DOCUMENT

### Patent Document

Patent Document 1: Japanese Patent Application Publication No. 2008-117558

### BRIEF DESCRIPTION OF THE DRAWINGS

FIG. 1 is a perspective view showing a light source device according to a first embodiment of the present invention;

FIG. 2 is an exploded perspective view of the device;

FIG. 3 is a plan view of the device;

FIG. 4 is a front view of the device;

FIG. 5 is a cross-sectional view of the device;

FIG. 6 is a plan view for explaining operation of the device;

FIG. 7 includes plan views and cross-sectional views showing conventional light source units;

FIG. 8 is a perspective view showing a light source device according to a second embodiment of the present invention;

FIG. 9 is a perspective view showing a state of attaching alight-shielding member to a light source unit of the device;

FIG. 10 is an exploded perspective view of the device;

FIG. 11 is a plan view of the device;

FIG. 12 is a cross-sectional view taken along a Y-Y line in FIG. 11;

FIGS. 13(a) and 13(b) are schematic explanatory diagrams showing states of light distribution, in which FIG. 13(a) shows a case of not providing light-shielding members and FIG. 13(b) shows a case of providing the light-shielding members;

FIG. 14 is a plan view showing a light source device according to a third embodiment of the present invention;

FIG. 15 is a cross-sectional view which is equivalent to FIG. 12;

FIG. 16 is a schematic plan view showing a light source device according to a fourth embodiment of the present invention;

FIG. 17 is a schematic plan view showing a light source device according to a fifth embodiment of the present invention;

FIG. 18 is a schematic plan view showing a light source device according to a sixth embodiment of the present invention;

FIG. 19 is a plan view showing an illumination device according to a seventh embodiment of the present invention;

FIG. 20 is a plan view of the device;

FIG. 21 is a side view of the device;

FIG. 22 is a cross-sectional view showing enlarged substantial parts of the device; and

FIG. 23 is a cross-sectional view showing enlarged substantial parts of the device.

### MODES FOR CARRYING OUT THE INVENTION

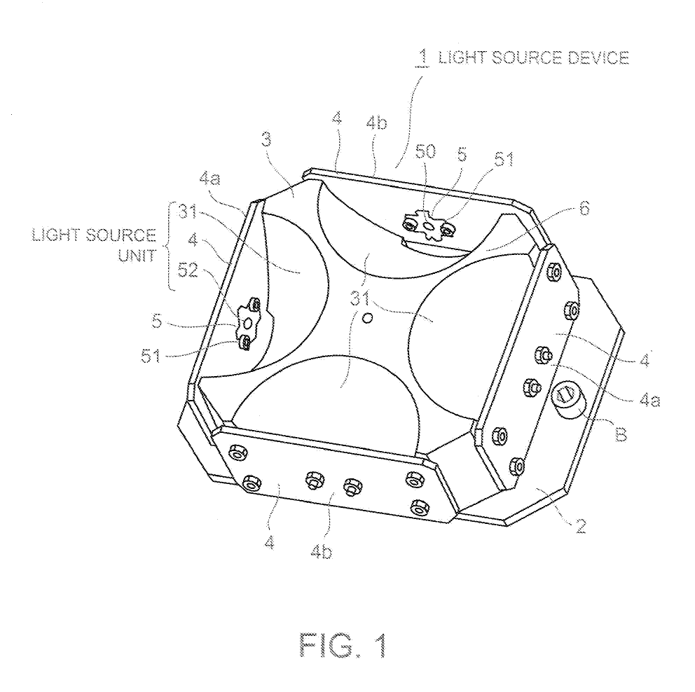

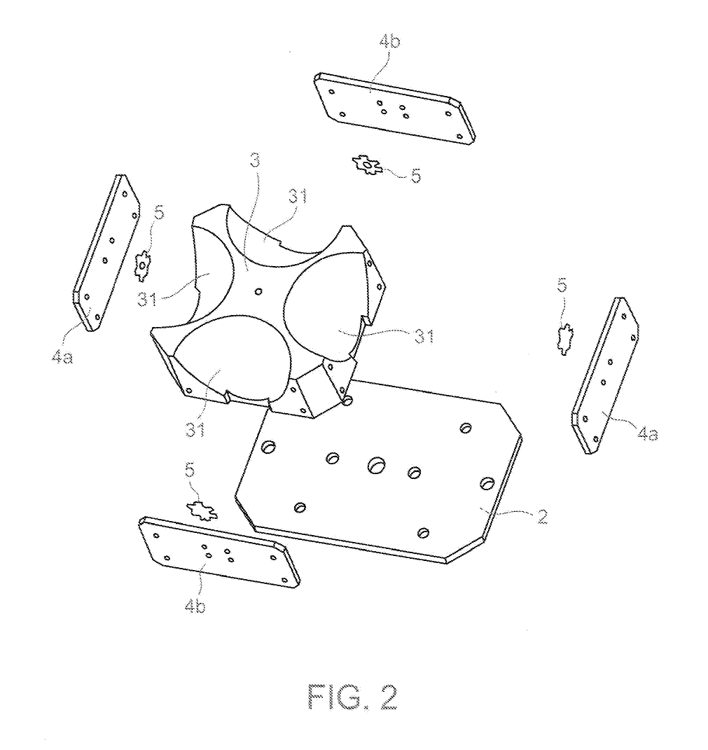

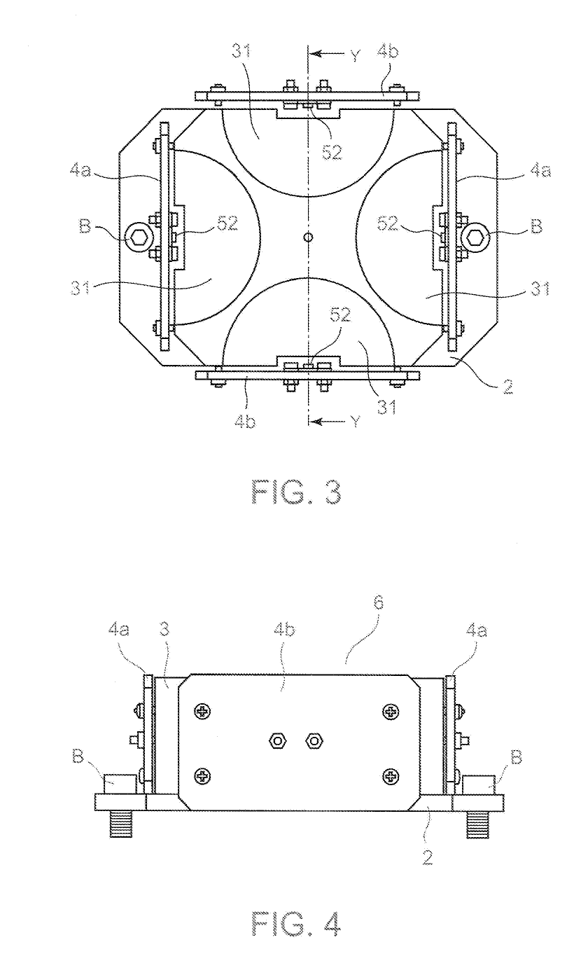

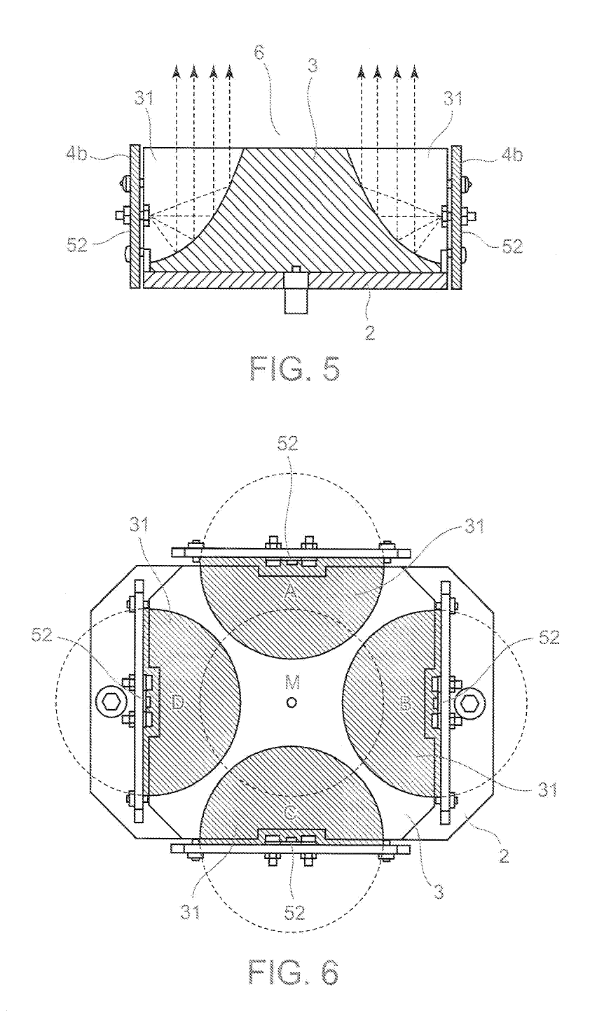

A light source device according to a first embodiment of the present invention will be described below with, reference to FIG. 1 to FIG. 6. FIG. 1 is a perspective view showing the light source device. FIG. 2 is an exploded perspective view showing an outline of the device. FIG. 3 is a plan view of the device. FIG. 4 is a front view of the device. FIG. 5 is a cross-sectional view of the device taken along a Y-Y line in FIG. 3. FIG. 6 is a schematic plan view for explaining operation of the device.

As shown in FIG. 1 to FIG. 5, a device body 1 serving as the light source device includes a base 2, and base plate attachment members 4 serving as side walls which are arranged to be vertical to the base 2. Moreover, a reflecting body 3 is attached to the base 2 and light source units 5 are attached to the base plate attachment members 4.

The base 2 is formed substantially into a rectangular plate shape in which corners are cut off. The base 2 is made of an aluminum material and is provided with bolt holes used for attachment to an illumination device to be described later, screw holes for fixing the reflecting body 3, and so forth (see FIG. 2).

The reflecting body 3 having a substantially rectangular parallelepiped shape as a whole is fixed to the base 2. The reflecting body 3 is integrally formed by use of metal such as aluminum, and more specifically, is fixed to the base 2 from a backside thereof with screws and the like. Moreover, reflecting surfaces 31 which are open outward are respectively formed at four side face portions of this reflecting body 3. This reflecting surface 31 is formed of a part of a curved surface, or namely as a paraboloid of revolution obtained by turning a parabola a half turn, for example. Therefore, in a plan view as shown in FIG. 3, the contour formed of an upper end portion of the reflecting surface 31 is formed into a semicircular shape that locates a circular arc portion inward and the four reflecting surfaces 31 are arranged to be rotationally symmetrical through 90°. Moreover, these reflecting surfaces 31 undergo mirror finish, white coating, and the like and are thus configured to increase reflectance.

Here, the reflecting surfaces 31 may be formed of separate members from the reflecting body 3. Further, the reflecting body 3 may be formed not only by use of metal but also by use of synthetic resin and the like. Meanwhile, the reflecting body 3 may be formed of divided blocks instead of integral formation, and be combined and integrated together.

Next, base plate attachment members 4a and 4b serving as the side walls and being opposed to one another are formed substantially into rectangular plate shapes, which are made of a material having good heat conductivity such as aluminum and have a function as heat conducting members. Moreover, the light source units 5 are attached to the inner surface side of these base plate attachment members 4a and 4b with screws.

The light source unit 5 includes a base plate 51, and a LED 52 serving as a light-emitting element that is mounted on this base plate 51. The base plate 51 is formed of a flat plate of glass epoxy resin being an insulative material, and a wiring pattern formed of a copper foil is provided on a front face side thereof. When the material of the base plate 51 is an insulating material, a ceramic material or a synthetic resin material having a relatively fine radiation characteristic and excellent durability is applicable. Alternatively, when the material is metal, it is preferable to apply a material such as aluminum which has good heat conductivity and an excellent radiation performance.

The LED 52 is a LED package of a surface-mounting type which basically includes a LED chip disposed on a body made of ceramics, and translucent molding resin such as epoxy type resin or silicone resin for sealing this LED chip. The LED chip is a blue LED chip configured to emit blue light. The translucent molding resin contains a phosphor which absorbs the light emitted from the LED chip and generates light in a yellow type color. The outgoing light from the LED chip is converted into a white type luminescent color such as white or warm white by way of the translucent resin on the LED package and is then emitted to the outside. Here, the LED may also be mounted directly on the base plate 51 by a chip-on-board technique. The mounting method is not particularly limited.

The base plate attachment members 4a and 4b to which the light source units 5 are attached as described above are attached to four side face portions of the reflecting body 3 by screwing two ends of the attachment members 4a and 4b. In the state where the base plate attachment members 4a and 4b are attached, the base plate attachment members 4a and 4b serving as the side walls are arranged parallel to a direction of radiation of the reflecting surfaces 31 as representatively shown in FIG. 5. Here, the LEDs 52 are opposed to and surrounded by the reflecting surfaces 31 each formed of the paraboloid of revolution obtained by turning the parabola a half turn, and the LEDs 52 are located at the focal points of the paraboloids of the reflecting surfaces 31.

Meanwhile, the base plate attachment members 4a and 4b are located with such a positional relationship that the attachment members 4a and 4b extend to be vertical to the base 2, and the reflecting surfaces 31 are each formed of a part of a curved surface spread and opened in the direction of radiation, i.e., from the base 2 toward a radiating portion 6. The reflecting surfaces 31 are disposed opposite to the LEDs 52 serving as the light-emitting elements so as to radiate the outgoing light from the LEDs 52 in a direction parallel to the base plate attachment members 4a and 4b. Moreover, as shown in FIG. 4, lower end portions of a pair of the base plate attachment members 4a facing each other contact and are thermally coupled to an upper surface of the base 2. Meanwhile, lower end portions of another pair of the base plate attachment members 4b extend to substantially the same positions as a lower surface of the base 2, and contact and are thermally coupled to a housing of the illumination device to be described later.

In this configuration, the base plate attachment members 4a and 4b serving as the side walls, the LEDs 52 serving as the light-emitting elements provided on these base plate attachment members 4a and 4b, and the reflecting surfaces 31 collectively constitute the light source units. Accordingly, a plurality of the light source units in the light source device, or namely, the four light source units are arranged to be rotationally symmetrical when viewed in the direction of radiation such that the curved surfaces of the reflecting surfaces 31 are directed to the center of the base.

Next, operation of the thus-configured embodiment will be described. The LEDs 52 emit the light when the LEDs 52 are energized by turning a power source on. The light is mainly reflected by the reflecting surfaces 31 and is radiated toward the radiating portion 6. Here, the LEDs 52 are located at the focal points of the reflecting surfaces 31, whereby the light directed toward the radiating portion 6 is radiated as parallel beams without being diverged or diffused inadvertently. Thus, it is possible to effectively irradiate an object with a spotlight and, moreover, to achieve facilitation of desired light distribution design.

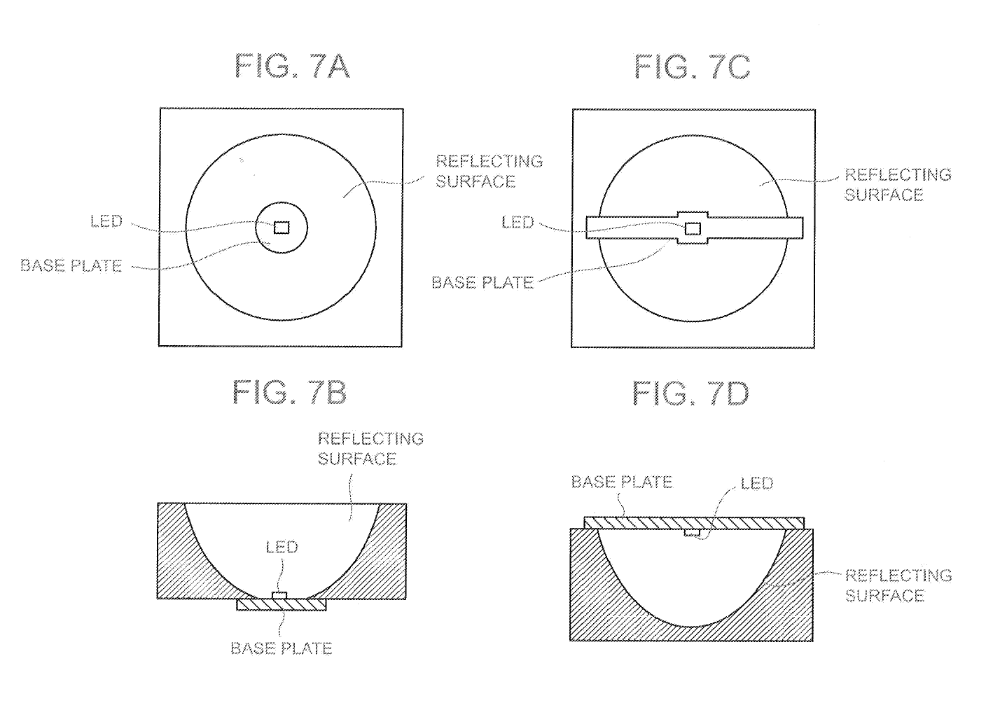

Subsequently, as shown in FIGS. 7(a) and 7(b), a conventional light source unit is configured to dispose a LED mounted on a base plate at a bottom portion of a reflecting surface which is formed into a bowl-like curved surface, for example. However, since the LED has a narrower radiation angle as compared to an incandescent lamp and the like, it is difficult to locate the LED at a focal point of the reflecting surface and it is not possible to utilize the reflected light by the reflecting plate effectively. Meanwhile, as shown in FIGS. 7(c) and 7(d), another conventional light source unit is configured to dispose a LED mounted on a base plate on an opposite side of a reflecting surface which is formed into a bowl-like curved surface, for example. However, since the LED may reduce optical output due to heat, the base plate for mounting the LED needs to be large. As a consequence, when the base plate is formed too large, the light from the LED is shielded by the base plate and radiation efficiency is thereby degraded.

On the other hand, the LEDs 52 in this embodiment are provided on the base plate attachment members 4a and 4b serving as the side walls so that the entire region of the reflecting surfaces 31 can be used effectively without causing troubles as observed in the conventional units.

In addition, it is also possible to efficiently transfer the heat generated from the LEDs.

Meanwhile, in a plan view as shown in FIG. 6, the reflecting surfaces 31 in this embodiment are formed into the four semicircular shapes each of which is equivalent to a substantially bisected circle drawn with a given radius. These four semicircular portions A, B, C, and D are the portions where the outgoing light from the LEDs 52 are radiated. Hence the area of these portions is proportional to illuminance and an increase in the area leads to improvement in the illuminance.

If this reflecting body 3 were formed with a LED located at a bottom portion of a reflecting surface formed in a bowl-like shape as in the conventional unit, thereby having a circular reflecting surface M (indicated with a dashed line) with the same radius as the reflecting surfaces 31, the area of this reflecting surface M would be about a half of the reflecting surfaces 31 of this embodiment. That is to say, having an area of a sum of A+B+C+D, this embodiment can secure the larger area than the area of the reflecting surface M and achieve improvement in the illuminance. In other words, the LEDs 52 are located on the base plate attachment members 4a and 4b serving as the side walls while the reflecting surfaces 31 are divided into the semicircular shapes, for example, and are arranged corresponding to the LEDs 52. In this way, it is possible to increase the proportion of the layout area occupied by the reflecting surfaces 31 on the upper surface of the reflecting body 3, i.e., to improve the density of the layout area of the reflecting surfaces 31. In addition, more LEDs 52 can be provided thereon. Accordingly, the device body 1 can be downsized while securing given illuminance.

As described above, according to this embodiment, it is possible to radiate the light effectively on the object and to facilitate desired light distribution design due to ease of alignment with the focal points. In addition, it is possible to use the reflecting surfaces 31 effectively and, moreover, to downsize the device body 1 while securing the given illuminance.

Note that the light-emitting element is formed of a solid-state light-emitting element such as an LED or an organic EL in this embodiment. Here, it is preferable to mount the light-emitting element by a surface mounting technique or the chip-on-board technique. Nevertheless, the mounting method is not particularly limited in light of the nature of the present invention. In the meantime, the reflecting surface formed into the curved surface includes reflecting surfaces formed into a paraboloid of revolution, an ellipsoid of revolution, and the like and are not particularly limited to specific aspects. Further, the base may be an independent member or a part of another member. The base means a portion of the light source device to be attached to the illumination device, for example. Meanwhile, the light source unit may be disposed on the base either directly or indirectly through another member. In short, the light source unit only needs to be located orthogonally to a radiating surface.

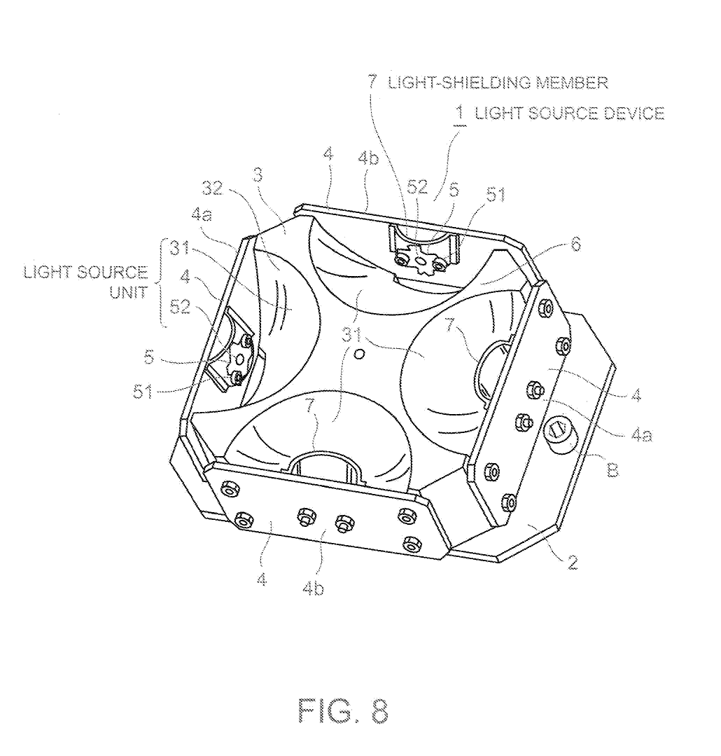

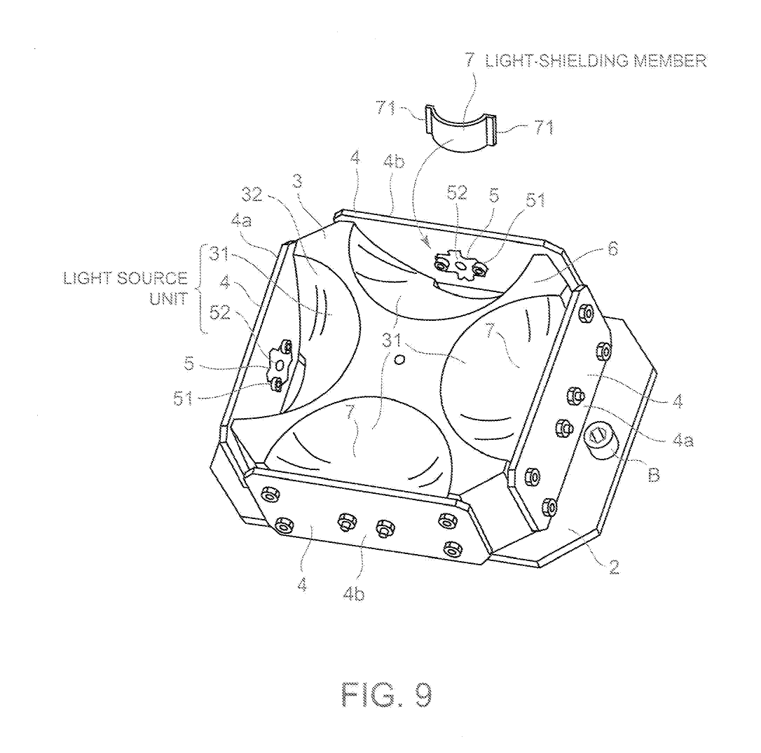

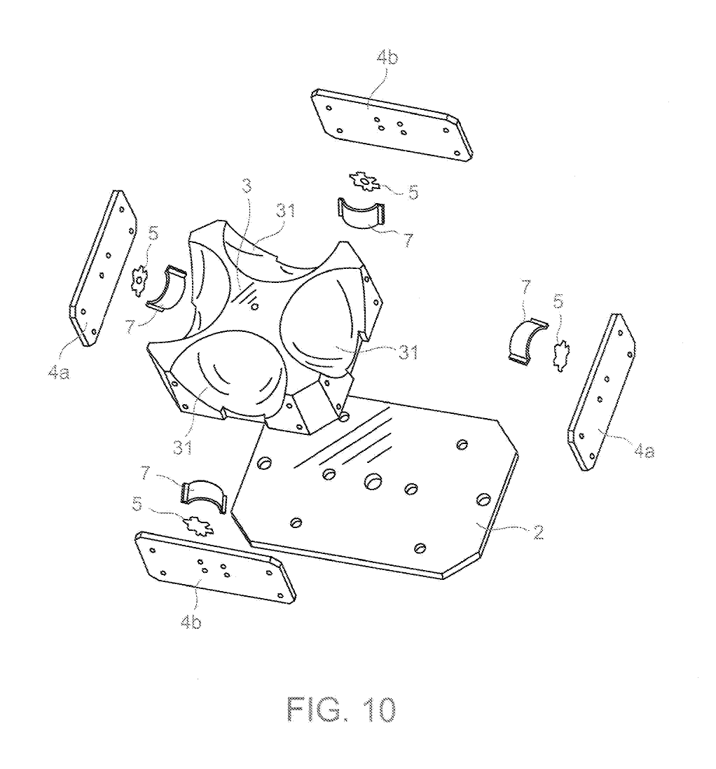

Next, a light source device according to a second embodiment of the present invention will be described with reference FIG. 8 to FIG. 13. A semicylindrical light-shielding member 7 is provided above the light source unit 5. This light-shielding member 7 is made of synthetic resin or metal. As representatively shown in FIG. 9 (note that FIG. 9 shows only one light-shielding member 7 out of four light-shielding members 7), attachment flanges 71 are provided on both sides of the semicylindrical shape. The attachment flanges 71 are attached to inner surface sides of the base plate attachment members 4a and 4b by means of adhesion or unillustrated fixtures such as screws. In this way, the light-shielding members 7 are arranged in predetermined positions on the base plate attachment members 4a and 4b.

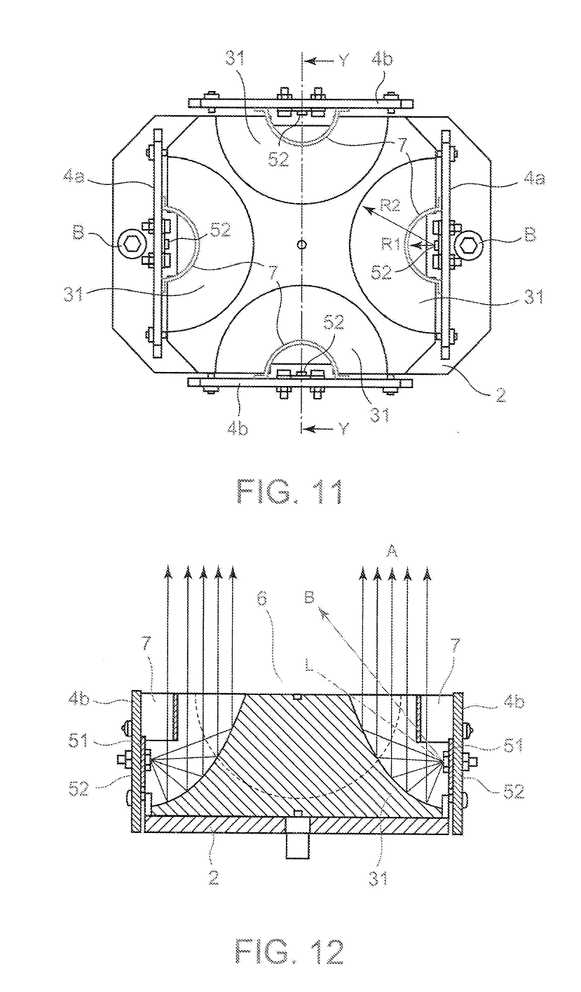

As shown in FIG. 12, the light-shielding member 7 is arranged such that one end (a lower end) thereof is located on a substantially straight line L connecting the LED 52 serving as the light-emitting element and an end portion in the direction of radiation of the reflecting surface 31 and that another end (an upper end) thereof extends in the direction of radiation to an upper end portion of the reflecting surface 31.

Moreover, as shown in FIG. 11, a semicircular arc portion R2 formed of the upper end portion of the reflecting surface and semicircular arc portion R1 formed of the light-shielding member 7 are formed concentrically around the LED 52. Therefore, as described later, this configuration has an advantage that it is easy to perform adjustment for shielding leaked light.

In the above-described configuration, the base plate attachment members 4a and 4b serving as the side walls, the LEDs 52 serving as the light-emitting elements located on these base plate attachment members 4a and 4b, the light-shielding members 7, and the reflecting surfaces 31 collectively constitute the Light source units. Accordingly, a plurality of the light source units in the light source device, or namely, the four light source units are arranged to be rotationally symmetrical when viewed in the direction of radiation such that the curved surfaces of the reflecting surfaces 31 are directed to the center of the base.

Next, operation of the thus-configured embodiment will be described mainly with reference to FIG. 12 and FIG. 13. The LEDs 52 emit the light when the LEDs 52 are energized through the base plates 51 by turning a power source on. The light is mainly reflected by the reflecting surfaces 31 and is radiated in a direction A toward the radiating portion 6. Here, the LEDs 52 are located at the focal points of the reflecting surfaces 31, whereby the light directed toward the radiating portion 6 is radiated as parallel beams without being diverged or diffused inadvertently. Thus, it is possible to effectively irradiate an object with a spotlight and, moreover, to achieve facilitation of desired light distribution design.

Moreover, one end of the light-shielding member 7 is located on the substantially straight line L connecting the LED 52 and the end portion in the direction of radiation of the reflecting surface 31. Accordingly, of the light emitted from the LED 52, direct light B that is not reflected by the reflecting surface 31 is shielded by the light-shielding member 7 and is therefore prevented from being radiated to the outside as leaked light, for example.

By locating the one end of the light-shielding member 7 on the substantially straight line L as described above, it is possible to suppress radiation of the unnecessary leaked light B to the outside without shielding effective light A supposed to be reflected by the reflecting surface 31.

As a result, a state of light distribution as shown in FIG. 13(b) can be realized. FIGS. 13(a) and 13(b) schematically show cross sections of states of light distribution, in which FIG. 13(a) shows a case of not providing the light-shielding members 7 and FIG. 13(b) shows a case of providing the light-shielding members 7. When the light-shielding members 7 are not provided, the leaked light B emerges on both sides of the effective light A reflected by the reflecting surfaces 31. On the other hand, the leaked light B is suppressed when the light-shielding members 7 are provided.

Meanwhile, since the light-shielding member 7 is formed into the semicylindrical shape, as shown in FIG. 12 for example, it is possible to easily set up a light shielding zone substantially across the entire range of the outgoing light that is emitted from the LED 52 by selecting a position to attach the light-shielding member 7 while adjusting the position in a vertical direction. Further, as shown in FIG. 12, the arc portion R2 of the reflecting surface 31 and the arc portion R1 of the light-shielding member 7 are formed concentrically around the LED 52. Therefore, it is similarly possible to easily set up the light shielding zone of the outgoing light from the LED 52 in relation to the arc portion R2 of the reflecting surface 31 by selecting the position to attach the light-shielding member 7 while adjusting the position in the vertical direction. Although it is preferable to form the light-shielding members into the semicylindrical shape, the shape is not limited in particular. For example, a flat plate shape and the like are also applicable. In the meantime, the expression “on the substantially straight line connecting the light-emitting element and the end portion in the direction of radiation of the reflecting surface” does not necessarily mean a strict relationship in a geometric sense.

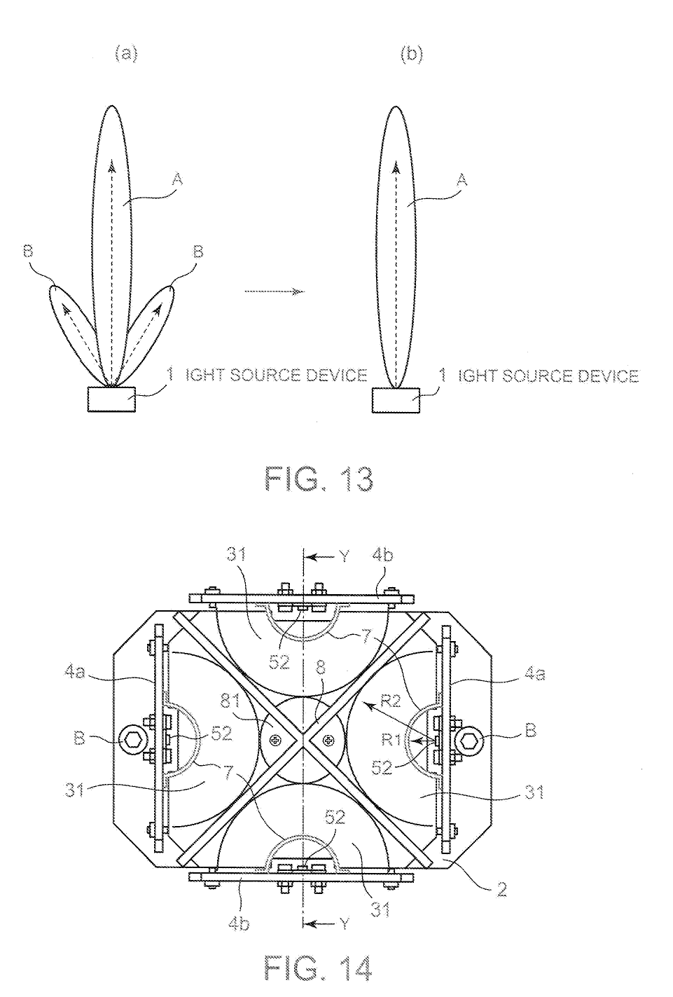

Next, a light source device according to a third embodiment of the present invention will be described with reference to FIG. 14 and FIG. 15. Here, identical or similar portions to those in the first and second embodiments will be designated by identical reference numerals and duplicate explanation will be omitted.

In this embodiment, a light-shielding body 8 protruding in the direction of radiation is provided on the radiating portion 6 side of the light source device body 1, or more specifically, on an opening portion 32 side of the reflecting surface 31. The light-shielding body 8 is formed substantially into a crisscross shape by use of louvers and is provided with a circular attachment plate 81 on one end sides of a central portion of the light-shielding body 8. The light-shielding body 8 is attached by fixing this attachment plate 81 to the upper surface of the reflecting body 31 with screws.

In the state where this light-shielding body 8 is attached, the reflecting surfaces 31 are surrounded in triangular shapes by the light-shielding body 8 as shown in FIG. 14. Moreover, as shown in FIG. 15, a height dimension H of the light-shielding body 8 is set to be higher than a position C where an extended line on the substantially straight line L connecting the LED 52 and the end portion of the reflecting surface 31 in the direction of radiation hits the louver of the light-shielding body 8.

The unintended leaked light is reliably suppressed by providing the light-shielding body 8 as described above. That is, although it is effective to provide the light-shielding member 7 to suppress the leaked light as described previously, it is necessary to perform fine positioning to locate the one end of the light-shielding member 7 on the substantially straight line L in order to prevent reduction of the effective light while suppressing the leaked light.

On the other hand, when the light-shielding body 8 is provided, this light-shielding body 8 can suppress the leaked light easily and reliably even when there is the leaked light which cannot be fully suppressed by the light-shielding member 7. As described above, according to this embodiment, it is possible to provide the light source unit and the illumination device which can achieve more reliable suppression of the leaked light in addition to the effects of the second embodiment.

In the first to third embodiments, the base may be an independent member or a part of another member. The base means the attachment surface, the attachment portion or the like of the light source device to be attached to the illumination device, for example. Meanwhile, the light source unit may be disposed on the base either directly or indirectly through another member.

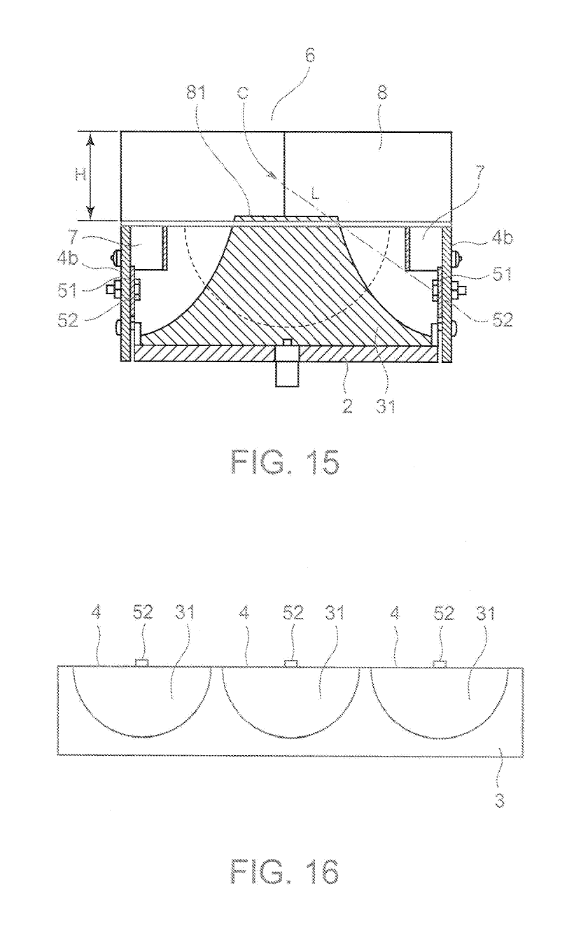

Next, the light source devices according to the first to third embodiments will be described with reference to FIG. 16 to FIG. 18. The drawings are schematic plan views of the light source devices. Here, identical or similar portions to those in the first embodiment will be designated by identical reference numerals and duplicate explanation will be omitted.

FIG. 16 shows a light source device according to a fourth embodiment, in which a plurality of the reflecting surfaces 31 of the reflecting body 3 are linearly arranged in a plan view. As similar to the first embodiment, the LEDs 52 are provided on the inner sides of the base plate attachment members 4 serving as the side walls. Therefore, according to this embodiment, it is possible to locate the LEDs 52 at the focal points of the reflecting surfaces 31, to radiate the light effectively onto an object, and to facilitate desired light distribution design.

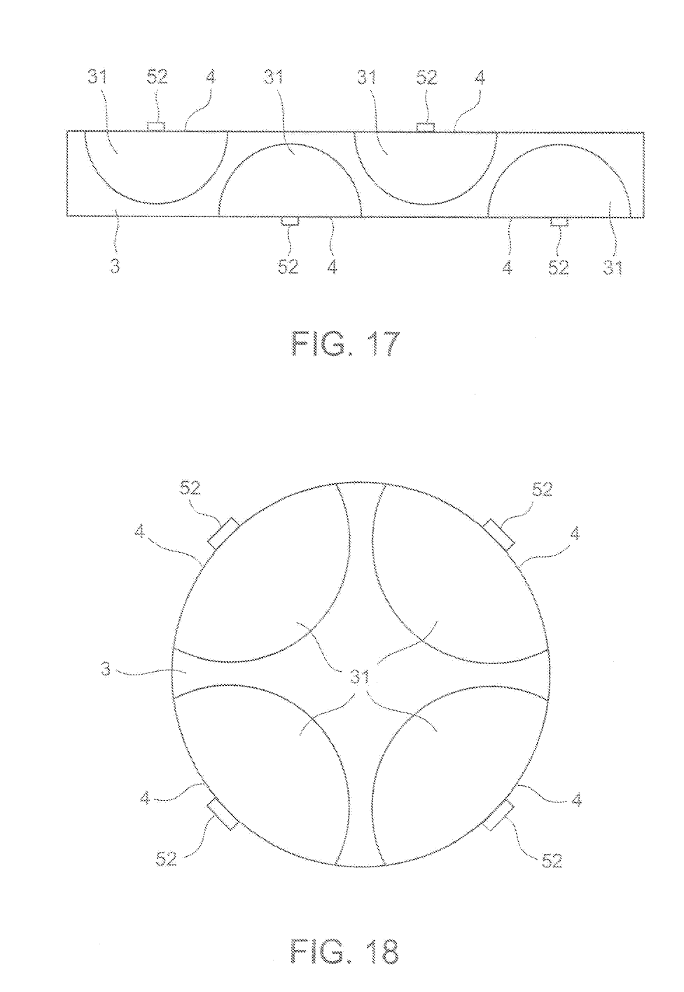

FIG. 17 shows a light source device according to a fifth embodiment, in which a plurality of the reflecting surfaces 31 of the reflecting body 3 are linearly arranged in a plan view while alternating orientations thereof. The LEDs 52 are provided on the inner sides of the base plate attachment members 4 opposed to each other. This embodiment can exert similar effects to those of the first embodiment.

FIG. 18 shows a light source device according to a sixth embodiment, in which the reflecting body 3 is formed substantially into a cylindrical shape and the LEDs 52 are located on a side wall thereof. The reflecting surfaces 31 are arranged to be rotationally symmetrical through 90° in a plan view. This embodiment can also exert similar effects to those of the first embodiment.

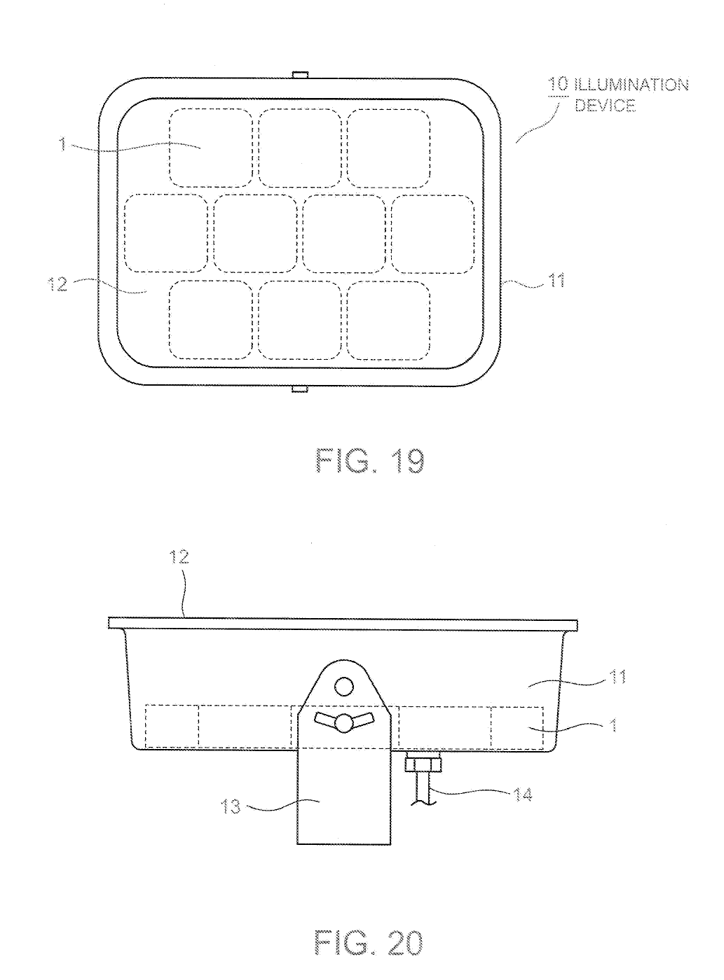

Next, an illumination device according to another embodiment of the present invention will be described with reference to FIGS. 19 to 23. The drawing is a schematic plan view of the light source device. Note that identical or similar portions to those in the first embodiment will be designated by identical reference numerals and duplicate explanation will be omitted.

The drawing shows a projector 10 serving as the illumination device. The projector 10 includes a box-shaped housing 11 serving as a main body, and a plurality of the light source devices embedded in this housing 11. The housing 11 has an opening portion on a front side and a translucent front cover 12 is attached to this opening portion through packing. This front cover 12 may apply a material such as polycarbonate or glass. Moreover, ten light source bodies 1 are arranged on a bottom wall inside the housing 11 and are attached thereto with attachment bolts B (as shown in FIG. 1, FIG. 3, and FIG. 4).

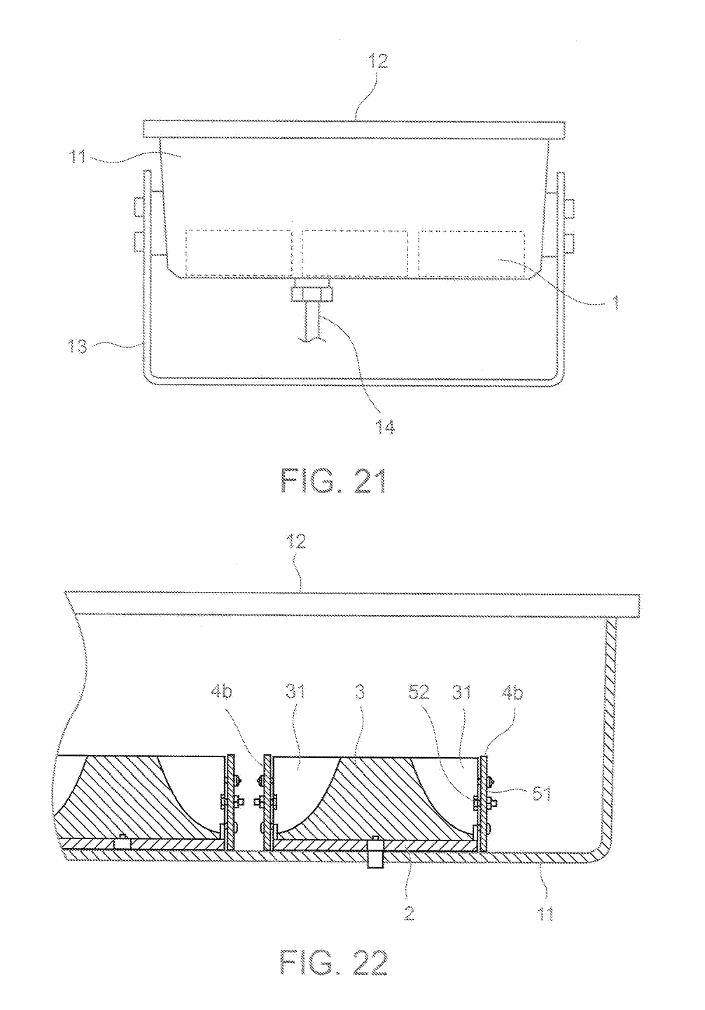

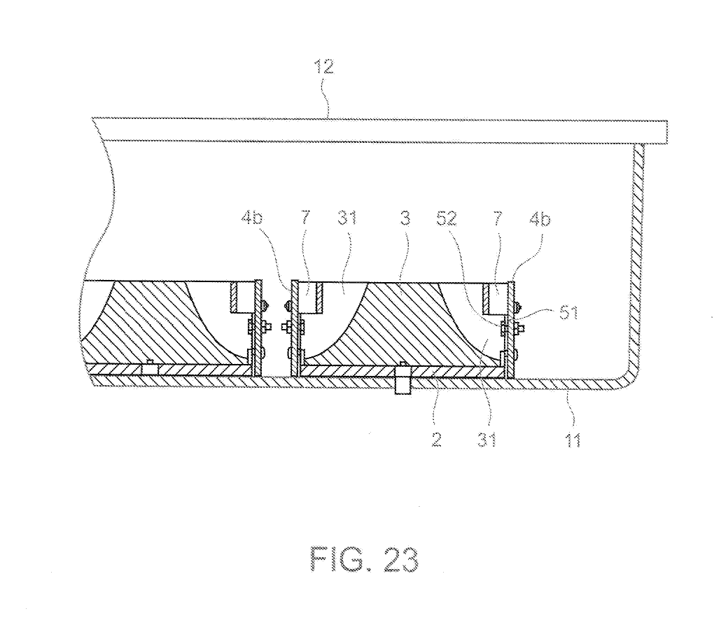

As shown in FIGS. 22 and 23, in the state where the device bodies 1 are attached to the bottom wall of the housing 11, the bases 2 of the light source devices establish surface contact with the bottom wall of the housing 11. Meanwhile, lower end portions of the base plate attachment members 4b also establish surface contact with the bottom wall of the housing 11. Hence the bases 2 and the base plate attachment members 4b are thermally coupled to the housing 11, respectively.

Here, the housing 11 is rotatably supported by a U-shaped arm 13 so that the housing 11 can change an elevation angle, or namely, the direction of radiation of the light. Meanwhile, a power line 14 is drawn out of the bottom wall of the housing 11 by use of a cable gland. This power line 14 is connected to the power source devices and to an unillustrated power supply device for supplying power to the light source devices.

The projector 10 configured as described above is installed on a building or the like by attaching the arm 13 thereto, for example, then is adjusted to radiate light in a direction toward an object, and is used by turning the power on. Accordingly, the light emitted from the light source devices is irradiated on the object through the front cover 12. In this case, the heat is generated by the LEDs 52. However, the heat is transferred to the base plate attachment portions 4 through the base plates 51. The heat from the base plate attachment members 4a is transferred from the base 2 to the housing 11 and the reflecting body 3 while the heat from the base plate attachment members 4b is transferred directly to the housing 11. Then, the heat transferred to the housing 11 is dissipated mainly from outer peripheries of the bottom wall and side walls of the housing 11. In this process, the side walls have a large surface area because a relatively large height dimension is provided. Hence a heat dissipating operation is effectively carried out. Here, it is possible to radiate the object effectively at targeted illuminance by appropriately selecting the number of the light source devices to be embedded in the housing 11.

In the embodiments of the present invention, the reflecting, surface is not limited only to the paraboloid of revolution obtained by revolving either a single parabola or a plurality of parabolas connected to one another. The reflecting surface may also be formed into other curved shapes such as an ellipsoid of revolution. In the embodiments, the base plate attachment members serving as the side walls are opposed to the LEDs so as to be parallel to the direction of radiation from the reflecting surfaces. However, the arrangement of the base plate attachment members does not always have to be parallel as long as it is possible to radiate in the direction of radiation of the illumination device. Meanwhile, the color to be emitted from the light-emitting elements is not limited only to white. It is possible to apply emission colors such as red, green or blue, to blend these colors into a desired color, and to apply variable colors. Further, the light source device may be formed without using the base serving as the independent member. For example, the light source device may be configured to be attached to the housing of the illumination device by attaching the reflecting body directly to the housing. Furthermore, while the projector is suitable for the illumination device, the invention is also applicable to various lighting apparatuses used indoors or outdoors.

Although certain embodiments have been described above, it is to be understood that these embodiments are illustrated merely as examples and are not intended to limit the scope of the present invention. In fact, the novel devices described herein may also be embodied in various other forms. Moreover, various omissions, replacements, and alterations of the embodiments of the devices stated herein may be made without departing from the gist or the spirit of the present invention. The appended claims and equivalents thereto are intended to encompass such embodiments or modifications to fall within the scope as well as the gist or the spirit of the present invention.

### CROSS-REFERENCE TO RELATED APPLICATIONS

This application is based upon and claims the benefit of the priority of the prior Japanese Patent Application No. 2009-185297 filed on Aug. 7, 2009 and Japanese Patent Application No. 2010-021683 filed on Feb. 2, 2010, the entire contents of which are incorporated herein by reference.

### EXPLANATION OF REFERENCE NUMERALS

1 light source device body
2 base
4 side wall (base plate attachment member)
6 radiating portion
7 light-shielding member
8 light-shielding body
10 illumination device (projector)
31 reflecting surface
52 light-emitting element (LED)

1. A light source unit characterized by comprising:
a light-emitting element; and
a reflecting surface opposed to the light-emitting element and formed of a part of a curved surface spread and opened in a direction of radiation.

2. The light source unit according to claim 1, characterized in that the reflecting surface is formed of a paraboloid of revolution obtained by revolving a parabola.

3. The light source unit according to claim 1, characterized in that the reflecting surface is formed of an ellipsoid of revolution obtained by revolving an elliptic curve.

4. A light source device characterized by comprising:
a base; and
a plurality of the light source units according to claim 1 which are located on the base,
characterized in that the plurality of light source units are arranged to be rotationally symmetrical to each other in a view from the direction of radiation so that the light source units are oriented toward the center of the base.

5. The light source device according to claim 4, characterized in that the base is formed in a polygon.

6. A light source device characterized by comprising:
a base; and
a plurality of the light source units according to claim 1 which are located on the base,
characterized in that the reflecting surfaces of the plurality of light source units are linearly arranged in a plan view.

7. The light source device according to claim 6, characterized in that the base is formed in a polygon.

8. An illumination device characterized by comprising:
a main body; and
a plurality of the light source devices according to claim 4 which are installed in the main body.

9. An illumination device characterized by comprising:
a main body; and
a plurality of the light source devices according to claim 6 which are installed in the main body.

10. A light source unit characterized by comprising:
a light-emitting element;
a reflecting surface opposed to the light-emitting element and formed of a part of a curved surface spread and opened in a direction of radiation; and
a light-shielding member arranged to have one end thereof located on a substantially straight line connecting the light-emitting element and an end portion of the reflecting surface in the direction of radiation, and to have another end thereof located at a position extended in the direction of radiation.

11. The light source unit according to claim 10, characterized in that the light-shielding member is formed into a semicylindrical shape.

12. The light source unit according to claim 11, characterized in that a semicircular arc portion formed of an upper end portion of the reflecting surface and a semicircular-arc portion formed of the light-shielding member are formed concentrically around the light-emitting element.

13. The light source unit according to claim 10, characterized in that
the reflecting surface includes an opening portion opened in the direction of radiation, and
a light-shielding body protruding in the direction of radiation is provided on an opening portion side of the reflecting surface.

14. An illumination device characterized by comprising:
a main body; and
a plurality of the light source units according to claim 10 which are installed in the main body.

15. An illumination device characterized by comprising:
a main body; and
four of the light source units according to claim 13 installed in the main body,
characterized in that the light-shielding body is formed substantially into a crisscross shape.
